(19) United States
(12) Patent Application Publication
(10) Pub. No.: US 2010/0069706 A1
(43) Pub. Date: Mar. 18, 2010

(54) ARTIFICIAL VAGINA FOR THE COLLECTION OF ANIMAL SEMEN

(75) Inventor: Christophe Rousere, Douai (FR)

Correspondence Address: HARNESS, DICKEY & PIERCE, P.L.C., P.O. BOX 828, BLOOMFIELD HILLS, MI, 48303, US

(73) Assignee: GENES DIFFUSION, Douai (FR)

(21) Appl. No.: 12/487,249

(22) Filed: Jun. 18, 2009

Related U.S. Application Data
(60) Provisional application No. 61/179,476, filed on May 19, 2009.

(30) Foreign Application Priority Data
Sep. 16, 2008 (FR) 08/05072

(51) Int. Cl. A61D 19/02; A61D 19/00

(52) U.S. Cl. 600/33; 604/349

(57) ABSTRACT

The artificial vagina for the collection of animal semen includes two half-shells capable of being positioned with regard to one another in order to form a tubular shell, said shell being rigid and open at its two extremities. A half-sleeve is accommodated inside each half-shell, in such a manner that once the two half-shells are positioned with regard to one another in order to form said shell, the two half-sleeves form a tubular housing that is suitable for receiving the penis of an animal, said housing being soft and capable of elastic deformation in a radial direction. At least one of the half-shells includes a lateral opening that allows radial pressure to be exerted manually through the half-shell onto the corresponding half-sleeve.

### CROSS-REFERENCE TO RELATED APPLICATIONS

This application claims the benefit of U.S. Provisional Application No. 61/179,476, filed on May 19, 2009. This application claims the benefit and priority of French Patent Application No. 08/05072, filed Sep. 16, 2008. The entire disclosures of the above applications are incorporated herein by reference.

### FIELD OF THE INVENTION

The present invention relates to the collection of animal semen. The object of the invention is a new artificial vagina that allows animal semen to be manually collected.

### PRIOR ART

In order to retrieve semen from an animal, such as for example a boar, bull, stallion, rabbit, etc., it has until now been the normal practice to use an artificial vagina to stimulate the animal's penis and to bring about ejaculation.

At present, there are several sorts of artificial vaginas of more complex or less complex structure, and which in general are adapted to the species of animal from which one wishes to retrieve the semen.

For example, in European Patent Application EP 0 699 422, a single-use artificial vagina of very simple structure is proposed, formed by a tubular sleeve made of a non-toxic foam of polyurethane, polyethylene or silicone. This artificial vagina of very simple structure allows animal semen to be collected manually, the penis of the animal having to be manually stimulated by the operator by means of pressure exerted with the help of the tubular sleeve made of foam.

This type of artificial vagina is advantageous because of its very simple structure. On the other hand, it displays at least the following inconvenience. The placing of the artificial vagina over the penis of the animal is carried out by slipping the vagina onto the penis, necessarily along the longitudinal axis of the vagina, which proves to be all the more impractical since the receiving conduit of the vagina is dimensioned to be of one size for all penises and in order to obtain a moderate tightening on the penis.

More sophisticated artificial vaginas are also known, which enable an automatic stimulation of the penis, particularly by means of a variable pressure chamber, supplied by a fluid such as water or air. For example, in International Patent Application WO 02/13723 an artificial vagina is disclosed that uses an impervious air chamber and that enables a localised stimulation of the animal's penis by means of pulsations. French Patent FR 946 822 describes another known embodiment of an artificial vagina for the automatic collection of animal semen using a pressure chamber filled with water or air.

These artificial vaginas using automatic stimulation are interesting because they facilitate the operation of collection for the operator. On the other hand, they are more costly to manufacture compared with the artificial vagina described in European Patent Application EP 0 699 422.

### OBJECT OF THE INVENTION

The principal object of the present invention is to propose a new artificial vagina for the collection of animal semen that has a simple structure that allows its manufacture and its implementation to be carried out at a low cost, while at the same time facilitating the collection operations for the operator.

### SUMMARY OF THE INVENTION

The object of the invention is therefore an artificial vagina for the collection of animal semen. It comprises two half-shells capable of being positioned with regard to one another in order to form a tubular shell, said shell being rigid and open at its two extremities; a half-sleeve is accommodated inside each half-shell, in such a manner that once the two half-shells are positioned with regard to one another in order to form said shell, the two half-sleeves form a tubular housing that is suitable for receiving an animal's penis, said housing being soft and capable of elastic deformation in a radial direction; at least one of the half-shells includes a lateral opening allowing radial pressure to be exerted manually through the half-shell onto the corresponding half-sleeve.

More particularly, the artificial vagina of the invention includes additional and optional characteristics, taken in isolation or, if need be, in combination:
the two half-shells include two lateral openings, which are diametrically opposed when the half-shells are positioned with regard to one another in order to form said shell, and which allow radial pressure by pinching to be exerted manually through the shell onto the two half-sleeves;
the two half-shells are articulated with regard to one another;
the artificial vagina comprises locking means allowing the two half-shells to be kept joined together;
the housing formed by the two half-sleeves is helicoidal;
the two half-sleeves protrude outside the half-shells with regard to one of the two extremities of the half-shells, namely the proximal extremity, and include two half-collars that cover the proximal edge of the half-shells;
the vagina comprises means at one extremity, namely the distal extremity, for the assembly of the artificial vagina with a collection device;
the artificial vagina is made by bi-injection.

### BRIEF DESCRIPTION OF THE DRAWINGS

Other characteristics and advantages of the invention will become clearer on reading the detailed description that follows, the description being given as a non-limiting and non-exhaustive example of the invention, and with reference to the attached drawings, in which:

FIG. 1 is a representation of an artificial vagina according to the invention, when the two half-shells are open;

FIG. 2 is a side view of the artificial vagina of FIG. 1;

FIG. 3 is a view from above of the artificial vagina of FIG. 1;

FIG. 4 is a view from below of the artificial vagina of FIG. 1;

FIG. 5 is a perspective view of the artificial vagina of FIG. 1, when the two half-shells are closed one upon the other;

FIG. 6 is a representation in perspective of a tightening device allowing pressure to be exerted on the sleeve of the artificial vagina;

FIG. 7 is a representation of an example of a device for the collection of animal semen that can be fitted on the artificial vagina according to the invention.

### DETAILED DESCRIPTION

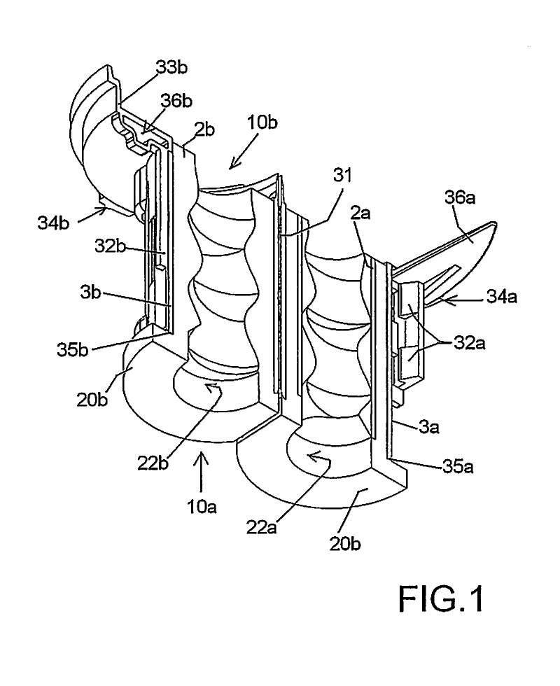

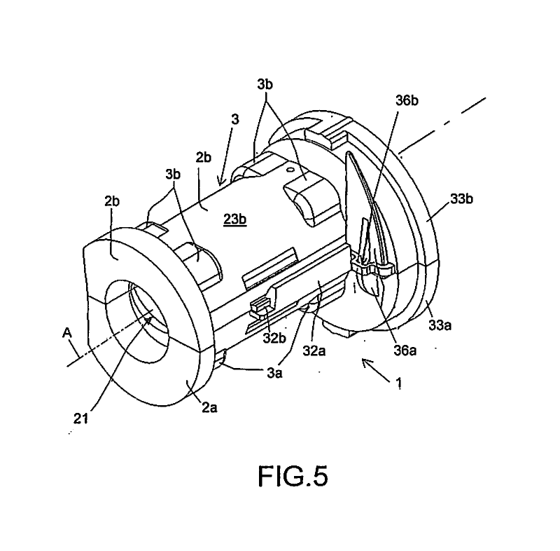

FIGS. 1 and 5 represent an embodiment of an artificial vagina 1 according to the invention, and which is destined, in particular, for the collection of porcine semen.

This artificial vagina 1 includes two half-shells 3a, 3b, which are rigid and rotationally articulated with regard to one another by means of a longitudinal hinge 31. These two articulated half-shells 3a, 3b are made for example of plastic. A soft half-sleeve 2a, 2b, which is capable of elastic deformation, is fixed inside each half-shell 3a, 3b. The two half-sleeves 2a and 2b each comprise an internal wall 22a, 22b, and an external wall 23a, 23b. In FIG. 1, the two half-shells 3a, 3b and their half-sleeves 2a, 2b are in the so-called open position. In FIG. 5, the two half-shells 3a, 3b and their half-sleeves 2a, 2b are in the so-called closed position.

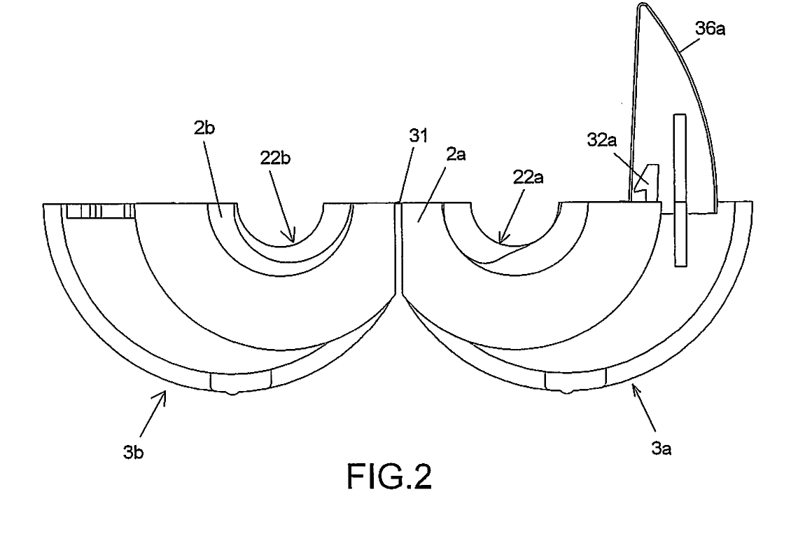

The longitudinal hinge 31 allows the artificial vagina 1 to change from the open position as shown in FIGS. 1 to 4, in which the artificial vagina 1 is capable of being positioned over the penis of an animal, to the so-called closed position, which is shown in FIG. 5, and in which the artificial vagina 1 is configured for causing the erection of the penis of the animal.

With reference to FIG. 5, when the two half-shells 3a, 3b are closed one upon the other, they form a tubular shell 3, which is rigid and open at its two extremities. When the two half-shells 3a, 3b are in this closed position, the two half-sleeves 2a, 2b demarcate an internal housing 21 of longitudinal axis A, which is substantially cylindrical or conical, and which is suitable for receiving the penis of an animal from which it is wished to retrieve the semen.

The two half-sleeves 2a, 2b are made of a material that is soft and that is capable of elastic deformation. Preferably this would be an elastomer or foam. Advantageously, the housing 21 ensures that the animal is not injured when the artificial vagina 1 is put in place and during the collection of the semen, while guaranteeing excellent comfort.

The structure consisting of two articulated half-shells allows the easy positioning of the penis of the animal in the housing 21 of the artificial vagina.

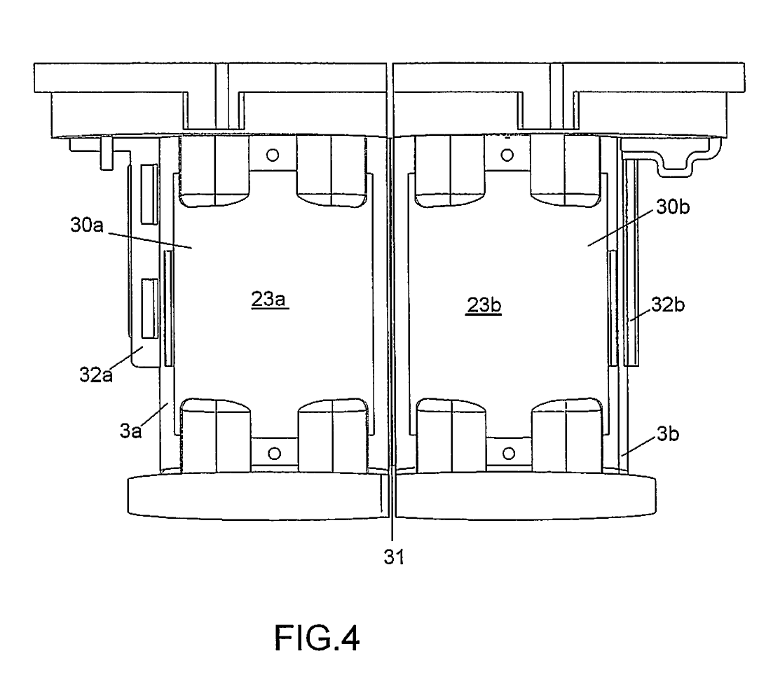

In the particular embodiment illustrated in FIG. 4, each half-shell 3a, 3b includes an opening 30a, 30b, which in the illustrated example forms a rectangular window. These openings 30a, 30b open respectively into the two half-sleeves 2a, 2b. When the two half-shells 3a, 3b are in the closed position as shown in FIG. 5, the two lateral openings 30a, 30b are diametrically opposed and allow radial pressure by pinching to be exerted manually through the shell onto the two half-sleeves 2a, 2b.

As shown in FIG. 1, the internal walls 22a, 22b of the two half-sleeves 2a, 2b are formed in such a way that the housing 21 formed by the two half-sleeves 2a, 2b has a helicoidal shape which is adapted for example to the penis of a boar. The invention is not limited, however, to a housing 21 of helicoidal shape, other shapes of the internal walls 22a, 22b of the housing 21 being possible.

In order to ensure that the artificial vagina 1 remains in the closed position when the penis of an animal is inside said vagina 1, the two half-shells 3a, 3b are provided with locking means 32a, 32b enabling the two half-shells 3a, 3b to be locked together in the closed position.

More precisely, the locking means comprise two lugs 32a on the half-shell 3a, which are capable of an interlocking relationship with a rib 32b on the other half-shell 3b, in order to keep the two half-shells 3a, 3b substantially joined together.

The locking means 32a, 32b have been described as a non-limiting example of the invention, it being possible to use any other mechanical means capable of keeping the two half-shells 3a, 3b closed. For example, straps could be used to keep the half-shells 3a, 3b in the closed position.

In FIG. 1, reference number 10a refers to the proximal extremity of the artificial vagina, which is destined to be slipped firstly onto the penis of the animal, while reference number 10b refers to the other extremity, namely the distal extremity, of the artificial vagina, through which the animal semen can flow during the collecting operation.

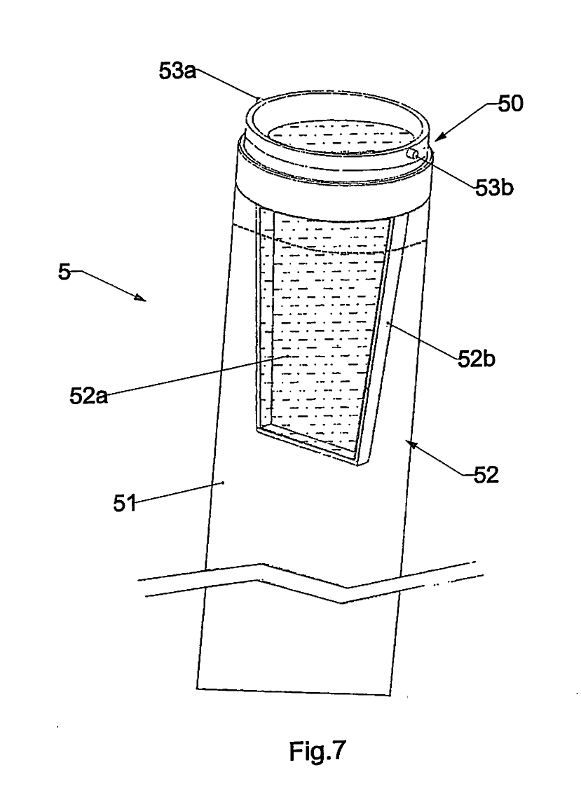

With reference to FIGS. 1 and 5, the two half-shells 3a, 3b include two supplementary half-collars 33a, 33b at the level of their distal extremity 10b. When the two half-shells 3a, 3b are in the closed position, the two half-collars 33a, 33b are joined together and form a rigid support that allows for the attachment of a collection means, such as for example the collection device 5 shown in FIG. 7, for the animal semen.

In the particular embodiment shown in FIGS. 1 and 5, in order to ensure the correct positioning of the two half-shells with regard to one another in the closed position, the half-shell 3a includes a male part 36a, which is capable of becoming temporarily interlocked in a female part 36b (forming a guide light) of the other half-shell 3b, when the two half-shells 3a, 3b come together. The guiding of the male part 36a by the female part 36b ensures a correct alignment of the two half-shells 3a, 3b in the closed position.

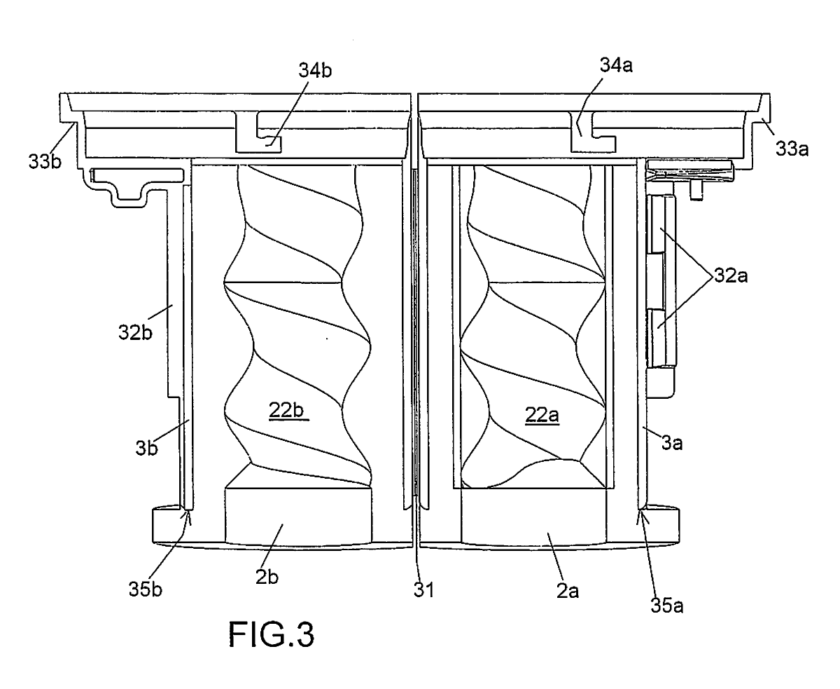

With reference to this FIG. 7, the collection device 5, which represents a non-limiting example of the invention, includes a rigid mounting ring 50 and a collection bag 51, integral with the mounting ring 50. A filtration cone 52, made out of non-woven material 52a fixed on a U-shaped frame 52b is foreseen inside the collection bag 51. The mounting ring 50 includes two lugs 53a, 53b, which are diametrically opposed and which are capable of being inserted respectively in two housings 34a, 34b (FIG. 3) arranged in the two half-collars 33a, 33b, when the two half-shells 3a, 3b are in the closed position. These lugs 53a and 53b, together with the two housings 34a, 34b, form a fixation system of the bayonet type.

Animal semen includes several different fractions: a first fraction is made up of a liquid containing the spermatozoa, as well as certain bacteria, and forms the seminal fluid; a second fraction is made up of a substance forming a kind of gel, also called “tapioca”. The filtration means 52 of the collection device 5 of FIG. 7 enables the second fraction to be advantageously retained, and to allow only the seminal fluid, constituting the fraction used for artificial insemination after the retrieval stage, to pass into the bottom of the bag 51.

The two half-sleeves 2a, 2b, which are soft and capable of elastic deformation, enable direct contact between the internal surface of the half-shells 3a, 3b and the penis of the animal to be avoided. Also, according to an optional characteristic of the invention, at the proximal extremity 10a of the artificial vagina 1, the two half-sleeves 2a, 2b protrude advantageously outside the half-shells 3a, 3b and include two half-collars 20a, 20b, which cover the proximal edge 35a, 35b of the half-shells 3a, 3b (FIGS. 1 and 3) in such a way that the proximal edge of the half-shells 3a, 3b cannot come into contact with the animal. In this way any risk of injury caused by the half-shells 3a, 3b to the animal is avoided.

The two articulated half-shells 3a, 3b on the one hand, and the two half-sleeves 2a, 2b on the other hand, can be manufactured separately and assembled afterwards, each half-sleeve 2a, 2b being fixed on a half-shell 3a or 3b by any means known to the person skilled in the art, for example by gluing. Nevertheless, in a preferred embodiment, the two articulated half-shells 3a, 3b and the two half-sleeves 2a, 2b are advantageously made in a single operation by bi-injection in a mould.

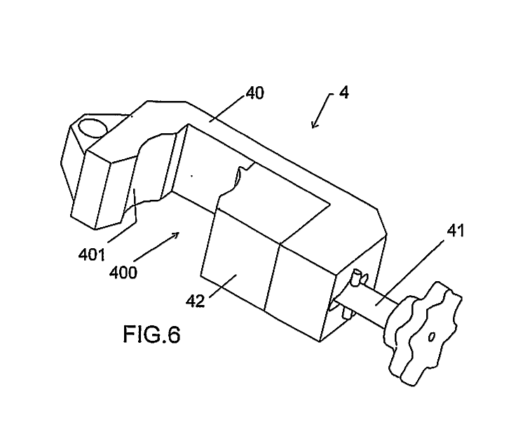

FIG. 6 represents a tightening device 4, which is capable of exerting supplementary pressure on the external wall 23a, 23b of the half-sleeves 2a, 2b by way of the openings 30a, 30b, such as to increase the stimulation on the penis of the animal at the ejaculation stage. The tightening device 4 comprises a support 40, a rod 41, and a mobile block 42. The rod 41 is mounted on the support 40 and the mobile block 42 is mounted on the rod 41.

More particularly, the support 40, substantially U-shaped, comprises an opening 400 into which the mobile block 42 can slide, by means of the rod 41. In this way, the artificial vagina 1 can come to be placed between the wall 420 of the block 42 and the wall 401 of the support 40. It is advantageous that the openings 30a and 30b of the shell 3 be arranged opposite the wall 420 of the block 42 on the one side and of the wall 401 of the support 40 on the other side. In this way, it becomes possible to tighten the two soft half-sleeves 2 with the help of the rod 41. For that purpose, one can use, for example, a threaded rod 41 in order to move said rod 41 forward in the opening 400, or else use a spring that will push the block 42 towards the wall 401 of the support 40.

The operation of collection of animal semen by means of the artificial vagina 1 is preferably carried out according to the following method.

### Stage 1:

The operator takes hold of the penis of the animal with the help of the open vagina 1 (the two half-shells 3a, 3b and the two half-sleeves 2a, 2b are not joined together). When the tip of the penis appears, the operator closes the artificial vagina 1 over the penis with the help of the closing means 32a, 32b (the two half-shells 3a, 3b are joined together and locked by means of the closing means 32a, 32b). The animal then experiences pressure, which leads it to the erection stage. The implementation of a vagina consisting of two articulated parts facilitates the positioning of the penis in the artificial vagina, and means that the vagina can be adapted to different sizes of penis.

### Stage 2:

The operator positions and connects a collection device 5 (FIG. 7) onto the distal extremity 10b of the vagina, more specifically on the joined together half-collars 33a, 33b of the shell 3. The function of this collection device 5 is to receive the animal semen that flows from the artificial vagina. The sort of collection device used is of no importance for the invention. It could for example be a soft receptacle like a bag, or a rigid or semi-rigid receptacle. Preferably, the operator fixes the artificial vagina 1 by means of its shell 3 onto a support, so that it is not necessary to carry it.

### Stage 3:

The pressure exerted on the penis of the animal by the artificial vagina 1 when it is closed is more often than not insufficient to bring the animal to the ejaculation stage. For that purpose, in order to increase the pressure on the penis of the animal, the operator can exert supplementary pressure on the external wall 23a, 23b of the two half-sleeves 2a, 2b by means of the openings 30a, 30b. The operator can exert this supplementary pressure manually by manually pinching the sleeve 2 at the level of the openings 30a, 30b or by using the tightening device 4 (as represented in FIG. 6) that will pinch the sleeve 2 at the level of the two openings 30a, 30b. The semen of the animal will then flow outside the sleeve 2 through the opening arranged in the distal extremity 10b of the artificial vagina, and is received in the collection device 5 mounted on the artificial vagina 1.

### Stage 4:

Once the ejaculation stage is completed, the penis is easily withdrawn from the artificial vagina 1 by releasing the locking means 32a, 32b, and by opening the two half-shells 3a, 3b. The operator removes the artificial vagina 1 and its collection device from its support, and separates the collection receptacle from the artificial vagina. When the artificial vagina (sleeve 2/shell 3) is for single use, or if it has become worn out, it is binned. It should be noted that in one embodiment, the order of stages 2 and 3 can be reversed.

The above method can be improved upon by carrying out stage 1 in the following manner. During the course of stage 1, the operator partly opens the two half-shells 3a, 3b of the artificial vagina and places a sanitary lining (commonly known as a liner) in the housing 21 that receives the penis, such that said sanitary lining covers the internal wall 22a, 22b of the two half-sleeves 2a, 2b, and such that a part of this sanitary lining extends beyond the proximal extremity 10a. Then the operator hitches up onto the artificial vagina that portion of the sanitary lining that extends beyond the proximal extremity 10a so as to partially cover said artificial vagina, and enabling the sanitary lining to be kept on the vagina. The two half-shells 3a, 3b are thus kept in a so-called partly opened position by the sanitary lining. Finally, the operator introduces the tip of the penis into the artificial vagina, by slipping it inside the sanitary lining, then he tightens the two half-shells 3a, 3b and closes the vagina with the help of the locking means 32a, 32b.

The sanitary lining enables the inside of the two half-sleeves 2a, 2b to be protected, and is generally discarded after use. It also has the function of improving the holding of the penis of the animal in the artificial vagina, thus avoiding the sliding of the penis within the housing 21.

The invention is not limited to the embodiment shown in the attached drawings, which has been described by way of a non-limiting and non-exhaustive example of the invention. In particular, the two openings 30a, 30b of the half-shells 3a, 3b are not necessarily identical. The artificial vagina 1 according to the invention does not include necessarily two openings 30a, 30b, since a single opening 30a or 30b could be sufficient for exerting radial pressure, either manually or with the help of the tightening device, in order to bring the animal to the ejaculation stage. The two half-shells are not necessarily articulated. In a different embodiment, the two half-shells 3a, 3b (with their half-sleeves 2a, 2b) can form two separate units, foreseen with means enabling their assembly in order to form the shell 3.

1. An artificial vagina for the collection of animal semen, comprising two half-shells capable of being positioned with regard to one another in order to form a tubular shell, said shell being rigid and open at its two extremities, and wherein a half-sleeve is accommodated inside each half-shell, in such a manner that once the two half-shells are positioned with regard to one another in order to form said shell, the two half-sleeves form a tubular housing that is suitable for receiving an animal's penis, said housing being soft and capable of elastic deformation in a radial direction, and wherein at least one of the half-shells includes a lateral opening that allows radial pressure to be exerted manually through the half-shell onto the corresponding half-sleeve.

2. The artificial vagina according to claim 1, wherein the two half-shells include two lateral openings, which are diametrically opposed when the two half-shells are positioned with regard to one another in order to form said shell, and which allow radial pressure by pinching to be exerted manually through the shell onto the two half-sleeves.

3. The artificial vagina according to claim 1, wherein the two half-shells are articulated with regard to one another.

4. The artificial vagina according to claim 1, further comprising locking means allowing the two half-shells to be kept joined together.

5. The artificial vagina according to claim 1, wherein the housing formed by the two half-sleeves is helicoidal.

6. The artificial vagina according to claim 1, wherein the two half-sleeves protrude outside the half-shells with regard to one of the two extremities of the half-shells, namely the proximal extremity, and include two half-collars that cover the proximal edge of the half-shells.

7. The artificial vagina according to claim 1, further comprising means at one extremity, namely the distal extremity, for the assembly of the artificial vagina with a collecting device.

8. The artificial vagina according to claim 1, made by bi-injection.
